(19) United States
(12) Patent Application Publication
(10) Pub. No.: US 2026/0368569 A1
(43) Pub. Date: Nov. 19, 2026

(54) METHOD FOR IMPROVING LANGUAGE MODEL PROCESSING THROUGH IN-CONTEXT LEARNING

(71) Applicant: Portland State University, Portland, OR (US)

(72) Inventors: Russell Scheinberg, Portland, OR (US); Ameeta Agrawal, Hillsboro, OR (US)

(21) Appl. No.: 19/677,971

(22) Filed: May 14, 2026

Related U.S. Application Data
(60) Provisional application No. 63/806,575, filed on May 15, 2025.

(51) Int. Cl. G06N 5/045

(52) U.S. Cl. CPC G06N 5/045

(57) ABSTRACT

A computer-implemented method for improving language model performance includes: prompting an explainer language model to generate a natural-language explanation of a system or phenomenon relevant to completion of a task of interest, wherein the explanation is arranged to describe principles, structures and/or constraints of the system or phenomenon that are relevant to the task of interest; storing the explanation in a storage device; and prompting a processor language model to generate a response to the task of interest, wherein the explanation is provided within a context window of the processor language model to inform processing by the processor language model.

### CROSS REFERENCE TO RELATED APPLICATIONS

The present application claims priority to U.S. Provisional Application No. 63/806,575, entitled “METHOD FOR IMPROVING LANGUAGE MODEL PROCESSING THROUGH IN-CONTEXT LEARNING”, filed May 15, 2025. The entire contents of the above-listed application is hereby incorporated by reference for all purposes.

### TECHNICAL FIELD

Embodiments of the subject matter disclosed herein relate generally to improving processing of large language models (LLMs) through in-context learning with an ‘explain-then-process’ framework that calls for a two-step prompting method that improves integration between LLMs'knowledge of systems and their ability to apply this knowledge to specific tasks.

### BACKGROUND AND SUMMARY

Large language models (LLMs) occupy an uncanny valley in that they appear almost human in their language use, excelling at tasks from text generation to translation to complex reasoning. However, these same language models show surprising gaps, particularly when asked to make explicit grammatical judgments—a limitation that becomes especially apparent in multilingual contexts. While LLMs generate fluent text, they often struggle to reflect on grammatical structure, suggesting a disconnect between their ability to use language and their capacity to reason about it.

Consider an example in which Claude 3.5 Sonnet is asked to reason out which of these minimal pair sentences is more grammatically acceptable:
(A) Only a popsicle that Danielle admires ever freezes.
(B) A popsicle that only Danielle admires ever freezes.

Sonnet incorrectly selected (B). Its reasoning has three steps:
(i) it paraphrases the meanings of the sentences as (A) “The only thing that ever freezes is a popsicle that Danielle admires” and (B) “A popsicle freezes only if Danielle, and no one else, admires it”;
(ii) Sonnet analyzes the paraphrases, noting that both (A) and (B) have the same “only”+“ever” pattern; and
(iii) Sonnet concludes that “both are grammatical”, and chooses (B) as ‘clearer’.

The paraphrase may hide the fact that “ever” is a negative-polarity item (NPI) which must be within the scope of “only.” In (A), “only” properly licenses “ever,” but in (B), it does not. By reducing both sentences to paraphrases, the model loses track of this licensing constraint and declares (B) acceptable.

This pattern has been observed across different LLMs and linguistic phenomena: when making acceptability judgements, models typically begin by paraphrasing (or translating) the sentences, and in this process frequently obscure the grammatical features that are crucial for accurate judgments.

What can be done to help models focus more directly on linguistic structure? To explore this question, a classic psycholinguistics task can be adopted: grammatical acceptability judgments. Specifically, we can evaluate whether models that can reliably distinguish unacceptable forms by using minimal pairs that differ by only one syntactic feature (e.g., a missing question particle). The focus can include three typologically distinct languages: English, Chinese, and Russian.

We distinguish between two kinds of linguistic compliance: formal—the knowledge of structural rules needed to differentiate grammatical from ungrammatical forms—and functional—practical language use in tasks like translation or summarization. While LLMs display strong functional competence in many cases, they may process implicit syntactic knowledge but fail to access it systematically, particularly in grammatical acceptability judgements.

Disclosed herein is an explain-then-process paradigm for grammar prompting, as illustrated in FIG. 1, which has two steps: first, a grammatical explanation of a given paradigm is elicited from an LLM; then the grammatical explanation is supplied back to the model before it provides an answer. This can be done in an interactive, prompt-based setting, and the interplay between grammar prompting and chain-of-though reasoning can be investigated. By equipping LLMs with these targeted prompts, it can be shown that language models more consistently identify syntactic violations, which suggests that explicit grammar guidance can unlock more systematic linguist reasonings.

Embodiments of the disclosed technology include the following: a novel explain-then-process paradigm that elicits explanations from models for a given task before using them for processing; a grammar prompting method that leverages explicit metalinguistic input to further unlock a model's linguistic reasoning and boost accuracy in minimal-pair grammatical acceptability tasks; and a systematic evaluation of multiple LLMs across English, Chinese, and Russian, analyzing how well grammar prompting structure improves their ability to make structured linguistic judgments.

Recent theoretical work suggests that LLMs possess considerable latent linguistic knowledge that can be activated through in-context learning (ICL) and introducing new linguistic information. For example, some have found that the effectiveness of targeted explanations and validation-tuned prompts to improve ability in specific tasks. Notably, one paradigm found that LLMs could improve translation between English and a zero-resource Papuan language, Kalamang, by consulting one grammar book. Follow-up work showed that incorporating explicit rules can help in some cases but might be insufficient without additional strategies such as validation-tuned prompts.

Grammatical acceptability judgment tasks have long been a fundamental method in psycholinguistics for assessing linguistic competence, typically presenting single sentences for evaluation. In computational linguistics, this task has been systematized using minimal pairs, that is, sentence pairs that differ by only one syntactic feature—allowing for more controlled comparisons. This approach led to the development of benchmark datasets such as the English-language CoLA and BLiMP, which have inspired similar resources for other languages, including Chinese, Russian, Arabic, Dutch, and Indonesian. While some computational approaches to minimal pair evaluation still rely on intrinsic metrics like perplexity or model-assigned probabilities, there is growing interest in prompt-based methods that explicitly ask models to make grammatical acceptability judgments, aligning more closely with how LLMs are used in interactive settings.

The grammatical acceptability task is a test case for a broader paradigm that allows language models to put into practice the knowledge about a problem or system that they are able to verbalize but not necessarily apply to said problem or system when prompted directly. The paradigm also allows increasing performance of smaller language models that can be more easily deployed locally or on edge devices, allowing these smaller language models to close the performance gap due to scaling difference between LLMs and SLMs, thus enabling deployment more safely and at lower cost (reduced compute and energy costs) than would be possible without applying the proposed method.

It should be understood that the summary above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

### BRIEF DESCRIPTION OF THE DRAWINGS

FIG. 1 illustrates the explain-then-process paradigm for grammar prompting in accordance with certain embodiments of the disclosed technology.

FIG. 2 illustrates an example of an instruction template for eliciting grammar explanations.

FIG. 3 illustrates an example of a Sonnet-generated ‘Beginner-Oriented’ grammar explanation for a linguistic paradigm.

FIG. 4 illustrates an example of an instruction for generating an explanation of a linguist paradigm.

FIG. 5 illustrates an example of a Sonnet-generated Expert grammar prompt for ‘left branch island echo question’BLiMP paradigm.

FIG. 6 illustrates an example of a Sonnet and o1-generated Beginner grammar prompt for ‘left branch island echo question’BLiMP paradigm.

FIG. 7 shows a flowchart illustrating a method for improving language model performance.

FIG. 8 shows a flowchart illustrating a method for efficient deployment of language models on edge devices with limited computational resources.

FIG. 9 shows a block diagram of an exemplary computing system configured to execute the explain-then-process paradigm.

### DETAILED DESCRIPTION

While large language models (LLMs) are often able to generate accurate descriptions and logical rules relating to systems, they do not consistently apply this understanding and knowledge when making judgments or reasoning about the related tasks. To address this disconnect, disclosed herein is an ‘explain-then-process’ framework, which calls for a two-step prompting method for improving integration between LLMs'knowledge of systems and their ability to apply this knowledge to specific tasks. The “explain-then-process” framework includes two steps:

Explain—an “explainer language model” (typically an LLM) can be used to generate an explanation of a system or phenomenon, outlining key constraints and objectives. The model may first generate a detailed description of a grammatical phenomenon, outlining key syntactic constraints; and

Process—a “processor language model” (which could be an LLM or a small language model (SLM)) can then be fed the explanation along with the processing task. The explanation guides decision-making and improves processing by focusing the model on more relevant categories to process the query.

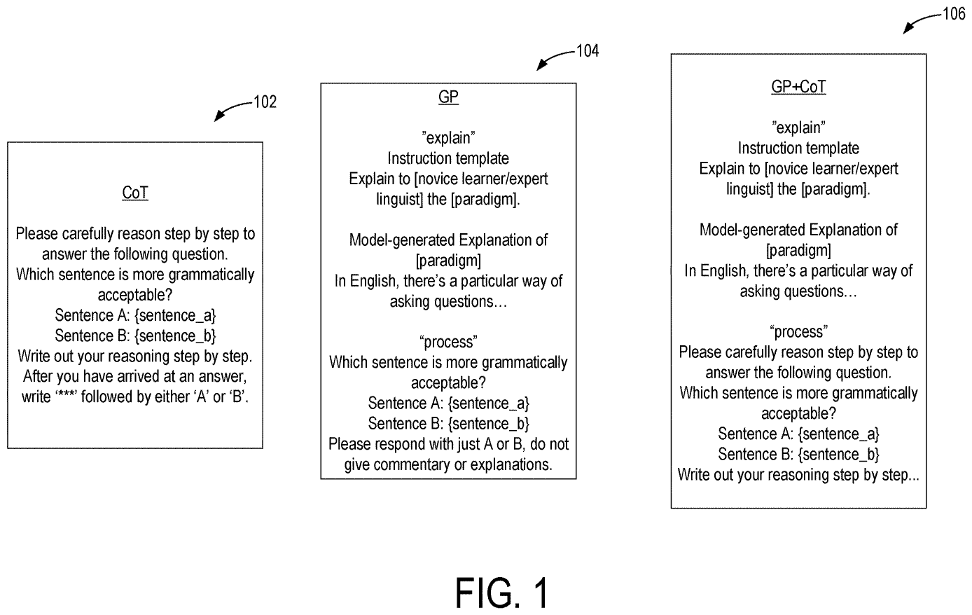

Starting with FIG. 1, examples of chain-of-thought (CoT) reasoning, Grammar Prompting (GP), and CoT+GP are shown. A CoT reasoning 102 may include a prompt such as “Please carefully reason step by step to answer the following question. Which sentence is more grammatically acceptable? Sentence A: {sentence_a}Sentence B: {sentence_b} Write out your reasoning step by step. After you have arrived at an answer, write ‘***’ followed by either ‘A’ or ‘B’. As illustrated above, this approach often does not yield accurate results. For example, an LLM may paraphrase the provided sentences, which may result in the model losing track of linguistic parameters like licensing constraints.

A GP reasoning 104 may include the explain-then-process framework of the present disclosure. In the example shown, the “explain” process includes an instruction template and a prompt such as “explain to [novice learner/expert linguist] the [paradigm]”. The model may the generate a model-generated explanation of the indicated paradigm. Based on this model-generated explanation, the model may then be asked to process a question, such as which of sentence A and B is more grammatically acceptable. The GP reasoning 104 may not elicit the LLM to provide a step-by-step reasoning for its decision.

A GP+CoT reasoning 106 may combine the two approaches, including the explain-then-process framework as well as eliciting the LLM to provide a step-by-step reasoning for its decision.

By explicitly linking grammatical descriptions to acceptability judgments, this approach tests whether LLMs can internalize syntactic rules. This is particularly important in multilingual settings, where access to explicit grammatical explanations is limited for many languages. Unlike English, which benefits from extensive linguistic resources, many languages lack formalized grammatical descriptions. Explain-then-process prompting allows LLMs to self-generate grammatical explanations, reducing reliance on external resources.

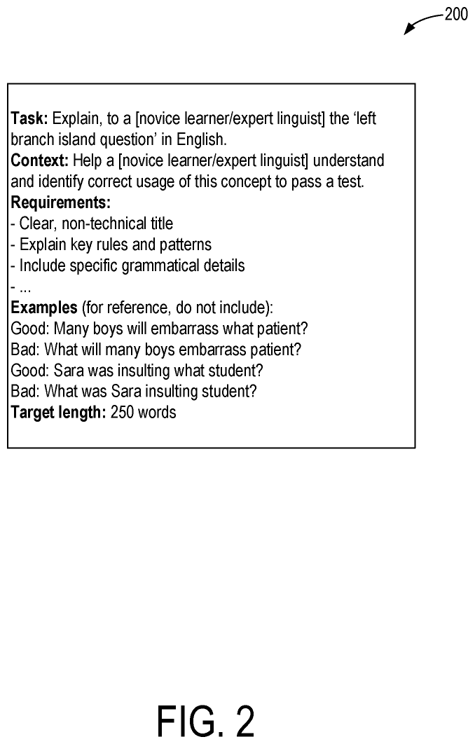

Turning now to FIG. 2, an example instruction template 200 for eliciting grammar explanations in the disclosed explain-then-process framework is shown. To elicit principled and consistent grammatical explanations from LLMs, an instruction template can be designed so as to ensure systematic coverage across languages and structures. Each template can include the grammatical paradigm name (e.g., NPI licensing), sample minimal pairs, and an instruction to avoid full example sentences, preventing reasoning based on examples. The instruction template can also specify a target audience: a request can be made for either a description for beginners with clear, straightforward explanations, or for experts with technical descriptions and formal terminology.

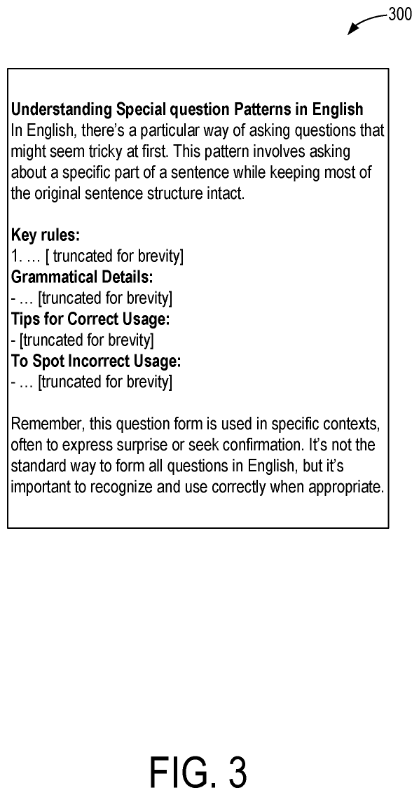

Next, these instructions can be used to ask LLMs to generate targeted grammatical explanations, or grammar prompts. FIG. 3 illustrates an example of a grammatical explanation generated by Sonnet. Given that the models we examine have English as their dominant training language, we used English prompts throughout, while the minimal pair sentences were in the target language.

This separation of roles between Explain and Process allows for more efficient resource allocation, as a more computationally expensive LLM can be used for the explanation phase and a lighter-weight SLM can handle the processing phase with the benefit of the LLM's explanation. Thus, the disclosed technology can advantageously utilize the ability of the explainer models to generate accurate descriptions to explain the most relevant aspects of a system in relation to a task, and then include the explanation in the processor model's context window when processing the task.

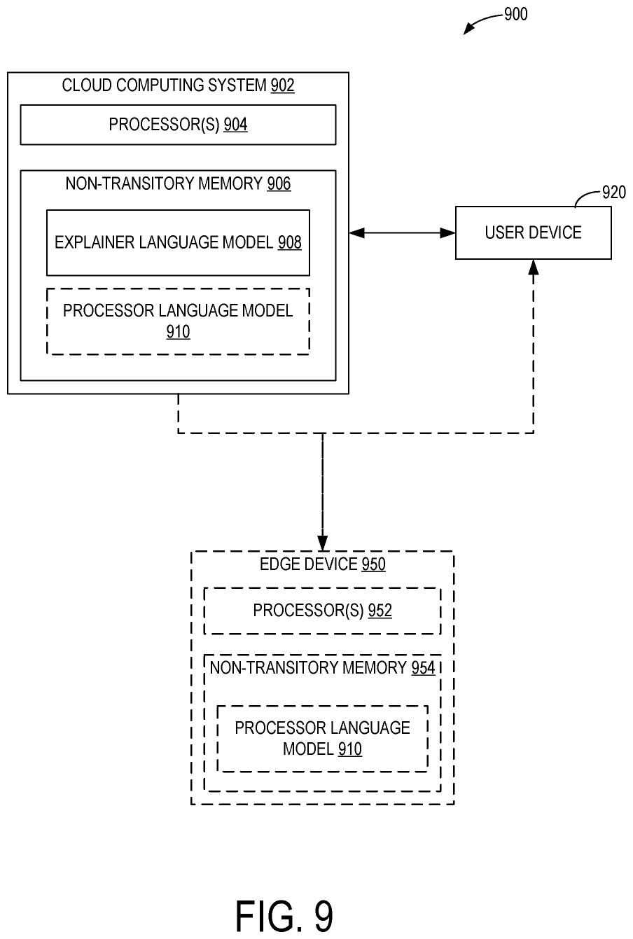

Turning briefly to FIG. 9, a computing system 900 is shown. The computing system 900 may provide the explain-then-process framework herein disclosed. As described herein below, the computing system 900 may include one or more language models for generation of a natural-language explanation of a language paradigm and a response to a task of interest with the context of the natural-language explanation.

In some examples, the computing system 900 may include a cloud computing device 902 that includes one or more processors 904 and non-transitory memory 906. The one or more processors 904 may be configured to execute machine readable instructions stored in the non-transitory memory 906. Processor(s) 904 may be single core or multi-core, and the programs executed thereon may be configured for parallel or distributed processing. In some embodiments, the processor(s) 904 may optionally include individual hardware components that are distributed throughout two or more devices, which may be remotely located and/or configured for coordinated processing. In some embodiments, one or more aspects of the processor(s) 904 may be virtualized and executed by remotely accessible networked computing devices configured in a cloud computing configuration. It should be appreciated that the cloud computing device 902 may include additional memory devices, including volatile memory, mass storage, local memory, and so on.

In some examples, the non-transitory memory 906 may include components disposed at two or more devices, which may be remotely located and/or configured for coordinated processing. In some embodiments, one or more aspects of the non-transitory memory 906 may include remotely accessible networked storage devices configured in a cloud computing configuration. The processor(s) 904 and the non-transitory memory 906 may be coupled, for example via a communication bus.

The memory 906 may store an explainer language model 908. The explainer language model 908 may be an LLM, in a non-limiting example. In some examples, the memory 906 may also store a processor language model 910. For example, both the explainer language model 908 and the processor language model 910 may be stored on the cloud server. In other examples, the processor language model 910 may be stored on an edge device 950. The edge device 950 may include one or more processors 952 configured to execute instructions stored in non-transitory memory 954, similar to as described above with respect to the cloud computing device 902. In examples in which the processor language model 910 is stored on the edge device 950, the processor language model 910 may be stored within the memory 954. In examples where the computing system 900 includes the edge device 950, the edge device 950 may be communicatively and/or operably coupled to the cloud computing device 902.

The computing system 900 may further include a user device 920 that is operably and/or communicatively coupled to the cloud computing device 902, and, if included, to the edge device 950. The user device 920 may include one or more input devices and one or more output devices. For example, the user device 920 may be a desktop computer, a laptop computer, a mobile device such as a smart phone or a tablet, or virtually any other technology. The display device(s) thereof may comprise, for example, a light emitting diode (LED), an organic light emitting diode (OLED), a liquid crystal display (LCD), a cathode ray tube (CRT) display, an in-place switching (IPS) display, a touchscreen, and/or the like. The input device(s) may comprise one or more of a touchscreen, a keyboard, a mouse, a trackpad, a motion sensing camera, a microphone, or other device configured to enable a user to interact with and manipulate data within the cloud computing device 902 and/or the edge device 950. In some examples, the user device 920 may include its own processor(s) and memory.

As an example, a user may input a prompt to the explainer language model 908 to generate an explanation of a phenomenon that is relevant to a task of interest. Via the user device 920, the user may provide an instruction template as well as a prompt such as “explain to a novice learner the ‘left branch island echo question’ paradigm in English.” The explainer language model 908 may generate an explanation of this paradigm and the explanation may be stored in the memory 906 of the cloud computing device 902 and/or transmitted to the edge device 950.

For example, when the processor language model 910 is stored in the memory 906 of the cloud computing device 902, the explanation may be stored in the memory 906 and accessed or retrieved by the processor language model 910 for generation of a response to the task of interest. When the processor language model 910 is stored at the edge device 950, the explanation may be transmitted to the edge device 950 for use by the processor language model 910 in response generation. In some examples, the explanation may be stored in the memory 906 of the cloud computing device 902 even when it is also transmitted to the edge device 950. In some examples, the edge device 950 may also store the explanation in its memory 954 temporarily or permanently. Thus, the same explanation may be used repeatedly by the processor language model 910 without having to have the explainer language model 908 repeatedly generate the same explanations, thereby reducing demanded processing power on the cloud computing device and reducing used bandwidth.

In some examples, the explanation, as generated by explainer language model 908 and/or the response to the task of interest, as generated by the processor language model 910, may be outputted to the user device 920 for display. As an example, a user interface of the cloud computing device 902 may be displayed on a display screen of the user device 920. The user may input the prompts (e.g., prompts to generate an explanation and prompts for the task of interest) and templates via this user interface and the explanation and/or response to the task of interest may be outputted to the user interface.

The explainer language model 908 and processor language model 910 may be the same model or different models. Empirical results have utilized two LLMs as explainer models and used both LLMs and SLMs as processor models and obtained excellent results in both cases. In particular, the disclosed framework allows for SLMs to achieve accuracy closer to that of LLMs, making it possible to deploy SLMs in lieu of LLMs for specific use cases, thereby reducing compute requirements, energy requirements and cost associated with LLMs. Explain-then-process thus makes smaller models more competitive and enables model deployment on smaller or less costly edge devices.

In certain embodiments, multi-agent systems can also be applied to the ‘explain’ phase and/or the ‘process’ phase of Explain-then-process, wherein separate models can be responsible for different aspects or subtasks of a system or problem.

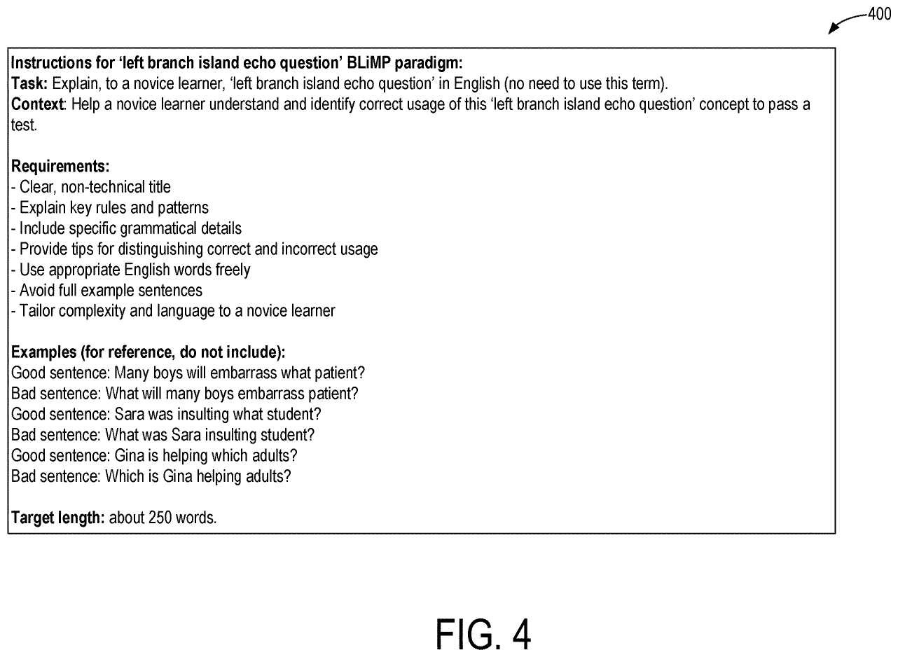

FIG. 4 illustrates an example of a prompt that can be inputted into an explainer language model, such as the explainer language model 908, for generation of an explanation of a grammar paradigm or phenomenon. The prompt may indicate the audience, such as a novice learner or a linguistic expert, what grammar paradigm is of interest (e.g., the left branch island echo question in English), and an instruction template which defines requirements for the explanation and examples of the paradigm.

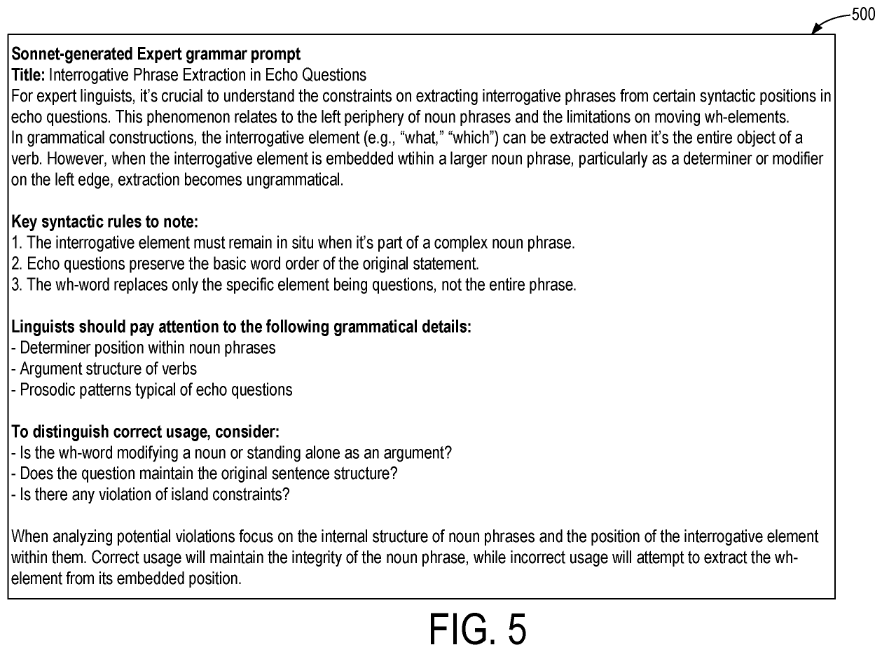

FIG. 5 shows an example of a Sonnet-generated explanation of the grammar paradigm based on the prompt shown in FIG. 4. In this example, Claude 3.5 Sonnet was used as the explainer language model for generation of the explanation.

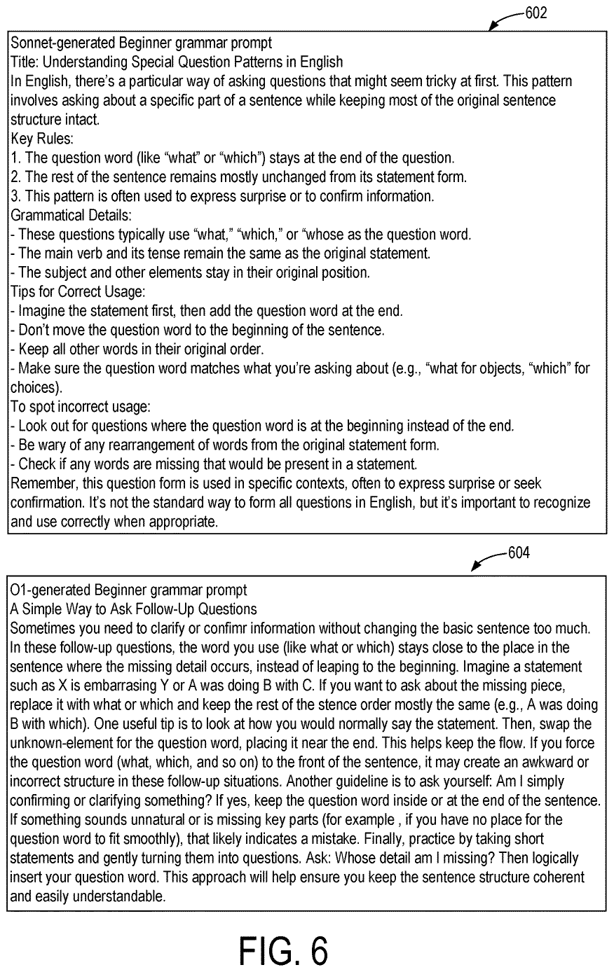

FIG. 6 shows a first example explanation 602 and a second example explanation 604 generated from the same prompt. The first example explanation 602 was generated using Claude 3.5 Sonnet and the second example explanation 604 was generated using OpenAI o1. As an example of the disclosed explain-then-process, extensive testing of the paradigm has yielded excellent results in relation to grammaticality judgment tasks: LLMs were asked to generate grammar explanations about linguistic phenomena in various languages, and it was found that the LLMs showed substantial performance gains and SLMs showed even greater performance gains. Explain-then-process prompting can be used to improve model competitiveness in various fields including, but not limited to, healthcare, legal analysis, code writing/auditing/security, and various other domains.

Results across English, Chinese and Russian reveal clear patterns how grammar prompting works with different linguistic phenomena. It is most effective for phenomena governed by simple distributional constraints and categorical distinctions, such as negative polarity items in English, aspect marking in Russian and Chinese, or alternative questions in Chinese. These often reach near-perfect accuracy under grammar prompting, likely because they involve specific functional elements (e.g., any, haishi, sebya) that operate under specific licensing environments or paradigmatic choices like Russian perfect/imperfect verb aspect.

In contrast, phenomena involving locality constraints such as English island phenomena or extensive lexical knowledge like Chinese classifier noun agreement show more modest improvements. While this could point to a limit on models'metalinguistic ability, another possible explanation is that the disclosed grammar prompt instruction template explicitly excluded example sentences to avoid them as a confound in the investigation.

With regard to the incorrect conclusion drawn by Sonnet using CoT noted above, with grammar prompting in accordance with the disclosed technology, Sonnet now reasons: “The key difference is the placement of “only”. In Sentence A, it's correctly placed at the beginning of the entire noun phrase, scoping over ‘a popsicle that Danielle admires’. In Sentence B, it's incorrectly placed inside the relative clause, which changes the meaning and doesn't follow the grammar rule explained. Therefore, Sentence A is more grammatically acceptable according to the provided explanation.”

With regard to the above discussion concerning the observation of how models can err by abstracting away surface but essential linguistic form in the attempt to decipher communicative intent; it can now be seen how, with the disclosed technology, grammar prompting can reduce problematic ‘semantically-driven reasoning’ by 1) harnessing the model's metalinguistic ability to generate a grammar prompt and 2) feeding the grammar prompt back to the model, thereby directing its reasoning process to operate over the relevant linguistic structure.

The disclosed work reveals a fundamental tension in how LLMs process language. LLMs are trained to distill away surface forms to capture meaning—a follow-the-benchmark strategy that has resulted in huge progress in functional tasks like translation or summarization. However, in tasks involving syntactic reasoning, the “meaning-first” approach can lead to ‘throwing the baby out with the bathwater’. It has been found that grammar prompting recalibrates LLMs'processing in two crucial ways:

From general to specific reasoning. Rather than relying on broad heuristics, grammar prompting anchors the model's attention on specific grammatical categories and constraints.

From implicit to explicit knowledge. Grammar prompting harnesses LLMs'ability to explain grammatical principles and then apply these explicit rules to make more accurate syntactic judgments. This approach opens promising directions for low-resource languages, where data-driven approaches fall short.

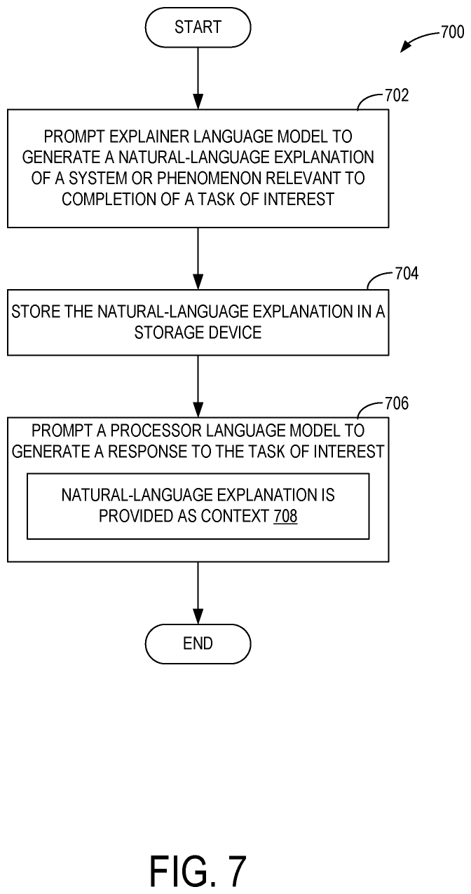

Turning now to FIG. 7, a flowchart illustrating a computer-implemented method 700 for improving language model performance is shown. The method 700 may be executed by one or more processors (e.g., processor(s) 906) according to instructions stored in non-transitory memory (e.g., non-transitory memory 908). The method 700 is herein described with respect to the system described herein with respect to FIG. 9, though it should be appreciated that the method 700 may also be executed by other systems. The method 700 may be executed in examples in which an explainer language model and a processor language model are both stored at a cloud computing device/system.

At 702, method 700 includes prompting an explainer language model to generate a natural-language explanation of a system or phenomenon relevant to completion of a task of interest. The explanation may be arranged to describe principles, structures and/or constraints of the system or phenomenon that are relevant to the task of interest.

At 704, method 700 includes storing the explanation in a storage device, such as a computer memory, as described above.

At 706, method 700 includes prompting a processor language model to generate a response to the task of interest. The explanation may be provided within a context window of the processor language model to inform processing by the processor language model, as at 708.

In certain embodiments, the explainer language model and the processor language model are the same language model.

In certain embodiments, the explainer language model is a large language model (LLM).

In certain embodiments, the processor language model is a small language model (SLM).

In certain embodiments, the processor language model is a multimodal model.

Certain embodiments may include one or more tangible, non-transitory storage media storing executable instructions that, when executed, cause a processor to perform the computer-implemented method.

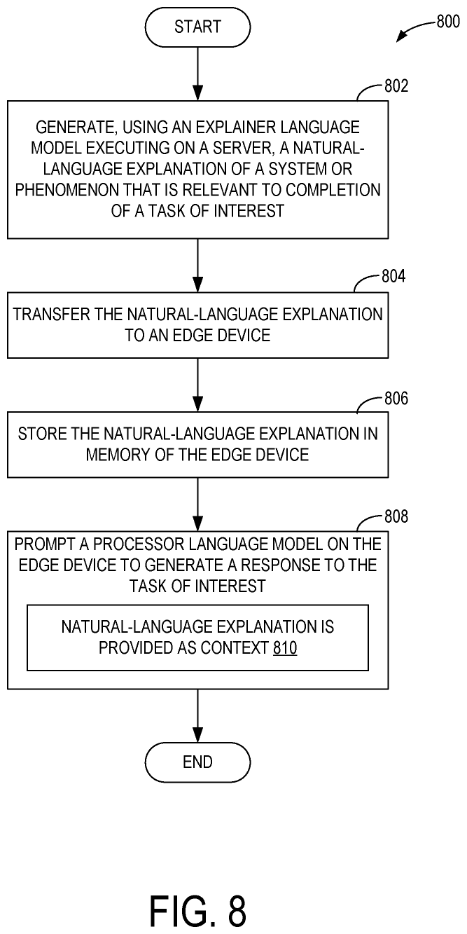

Turning now to FIG. 8, a flowchart illustrating a computer-implemented method 800 is shown. The method 800 is herein described with respect to the systems of FIG. 9, though it should be appreciated that the method 800 may be executed by other systems. The method 800 may apply to the example in which an explainer language model is stored on a cloud computing device and a processor language model is stored on an edge device.

At 802, method 800 includes generating, using an explainer language model executing on a server, a natural-language explanation of a system or phenomenon that is relevant to completion of a task of interest.

At 804, method 800 includes transferring the explanation to an edge device. As described herein, the edge device may comprise a processor executing a processor language model with fewer parameters than the explainer language model. For example, the explainer language model may be an LLM while the processor language model may be an SLM.

At 806, method 800 includes storing the explanation in a memory of the edge device.

At 808, method 800 includes prompting the processor language model on the edge device to generate a response to the task of interest. The explanation may be provided within a context window of the processor language model to inform processing by the processor language model, as at 810.

The separation of the explain phase and the process phase across distinct computing devices, specifically a cloud computing device executing the explainer language model and an edge device executing the processor language model, constitutes a specific architecture that results in increased system efficiency not achievable by a single-device, single-pass inference approach. By transferring and caching the explanation on the edge device, the system reduces repeated round-trip communications to the cloud server, reduces inference latency, and enables operation in environments with limited or intermittent network connectivity.

In certain embodiments, the explainer language model and the processor language model are the same language model.

In certain embodiments, the explainer language model is a large language model (LLM).

In certain embodiments, the processor language model is a small language model (SLM).

In certain embodiments, the processor language model is a multimodal model.

Certain embodiments may include one or more tangible, non-transitory storage media storing executable instructions that, when executed, cause a processor to perform the computer-implemented method.

The present disclosure addresses a specific technical deficiency in the architecture of language model inference pipelines. Conventional language model inference involves a single-pass prompting architecture, such as the CoT example 102 of FIG. 1, in which a model's latent linguistic or domain knowledge is not systematically surfaced and reinjected into the model's context window prior to task processing. This architectural limitation results in measureable degradation of output accuracy, particularly for tasks requiring structured reasoning over implicit model knowledge. The explain-then-process framework disclosed herein constitutes a specific improvement to the inference pipeline architecture of language model systems, enabling more accurate outputs without retraining, fine-tuning, or modifying model weights. Thus, accuracy of generated outputs may be increased while reducing computational burden through a specific arrangement of model invocations and memory operations.

The disclosed explain-then-process framework produces concrete, measurable technical improvements in language model system performance, including: 1) increased accuracy of processor language model outputs without modification of model weights or retraining; 2) reduced computational resource consumption by enabling deployment of smaller language models on edge devices in lieu of larger language models or cloud-hosted language models for specific tasks, thereby reducing processor load, memory consumption, energy consumption, and the like; 2) reducing network bandwidth consumption by storing a single generated explanation locally on an edge device for repeated use, mitigating the need for repeated cloud-based inference calls; and 4) reduced latency in inference pipelines by offloading processing tasks to local edge devices equipped with the stored explanation.

The above described methods may be utilized in various applications. In each of the various applications of the methods described below, the explainer language model deployed during an explain phase may be an LLM and the processor language model deployed during the process phase may be the same LLM as the explainer language model, a different LLM from the explainer language model, or an SLM.

In a first example relating to language learning enhancement, during an explain phase, an explainer language model may generate an explanation of some combination of linguistic principles, grammatical structures, idiomatic expressions, and cultural context relevant to the language being learned. Then, during a process phase, a processor language model may apply these linguistic explanations to specific language learning tasks such as grammar correction, error explanation, translation practice, or conversion simulation tailored to the learner's proficiency level.

In this way, the processor model can provide more accurate and pedagogically sound language instruction by leveraging explicit linguistic knowledge. Further, language learning applications can be deployed on personal devices with lower computational requirements and explanations can be customized to address specific learning challenges or mother-tongue interference patterns while maintaining consistent processing capabilities.

In a second example relating to multilingual task processing, during an explain phase, an explainer language model may generate explanations of some combination of cross-linguistic patterns, translation principles, and language-specific idiosyncrasies relevant to processing content across multiple languages. Then, in a process phase, a processor language model may apply these linguistic insights to perform specific multilingual tasks such as cross-lingual information retrieval, sentiment analysis across languages, or culturally-appropriate content adaptation.

In this way, the processor language model can handle multilingual tasks with greater accuracy by incorporating explicit cross-linguistic knowledge. Further, organizations can deploy multilingual capabilities on local infrastructure rather than requiring extensive cloud resources. Additionally, linguistic explanations can be updated to incorporate new languages or linguistic features without requiring complete retraining of the processor language model.

In a third example relating to low-resource language processing, during an explain phase, an explainer language model (e.g., an LLM) may generate explanations of some combination of linguistic structures, grammatical rules, morphological patters, and orthographic conventions specific to low-resource languages that have limited available digital text or training data. Then, during a process phase, a processor language model may apply these linguistic explanations to perform specific tasks in low-resource languages, such as text analysis, content generation, or translation, despite having minimal prior exposure to examples in these languages.

Thus, the processor language model can achieve higher accuracy in processing low-resource languages by leveraging explicit linguistic knowledge. In this way, language technology can be extended to underserved linguistic communities without requiring massive language-specific datasets. The approach thus enables rapid adaptation to previously unsupported languages by generating linguistic explanations rather than collecting extensive language-specific corpora.

In a fourth example relating to medical diagnosis support, during an explain phase, an explainer model may generate an explanation of some combination of a specific medical condition, including key symptoms, diagnostic criteria, common comorbidities, and relevant risk factors. Then, during a process phase, a processor model may receive patient data along with the explanation and may perform the specific task of suggesting potential diagnoses or treatment pathways.

Thus, the processor language model can make more accurate diagnostic suggestions without needing the full medical knowledge embedded in larger models. This further reduces computational requirements, which allows local deployment in resource-constrained clinical settings without having to send sensitive information to a remote LLM. Further, explanations provided by the explainer language model can be customized to different medical specialties while using the same processor model.

In a fifth example relating to accessibility and assistive technologies on a user device, during an explain phase, an explainer language model may generate explanation(s) of accessibility principles, user-specific needs, interaction patterns, and assistive technology requirements relevant to a particular disability or combination or disabilities. Then, during a process phase, a processor language model may apply these accessibility explanations to perform specific tasks such as adapting content, simplifying complex information, generating alternative descriptions, and/or creating personalized user interfaces optimized for the user's particular needs.

Thus, the processor language model can provide more effective assistive features by incorporating explicit knowledge of accessibility requirements. Further, accessibility solutions can be deployed directly on users'personal devices without requiring constant cloud connectivity and explanations can be customized to address specific disabilities or combinations of disabilities while maintaining efficient local processing.

In a sixth example relating to technical writing and documentation, during an explain phase, an explainer language model may generate explanations of technical documentation principles, domain-specific terminology, audience-appropriate communication patterns, and information architecture best practices relevant to the content being created. Then, during a process phase, a processor language model may apply these documentation guidelines to specific technical writing tasks such as procedure creation, concept explanation, API documentation, or knowledge base maintenance appropriate for different user expertise levels.

Thus, the processor language model can produce higher quality technical documentation by leveraging explicit knowledge of documentation best practices. Further, documentation systems can operate on local infrastructure with lower computational requirements and explanation frameworks can be updated to incorporate new style guides or domain terminology without retraining the processor model.

In a seventh example relating to publishing and media production, during an explain phase, an explainer language model may generate explanations of narrative structures, content formatting standards, genre conventions, and audience engagement principles relevant to the specific media format and target audience. Then, during a process phase, a processor language model may apply these media production guidelines to specific tasks such as content drafting, narrative structure organization, style consistency checking, or audience-appropriate tone adaptation across multiple content pieces.

Thus, the processor model can generate more effective media content by incorporating explicit knowledge of publishing principles. Additionally, media production tools can operate on creators' local devices without requiring extensive cloud resources and explanation frameworks can be customized for different publication formats, genres, or audience segments while maintaining consistent processing capabilities.

In an eight example relating to legal analysis for contract review, during an explain phase, an explainer language model may generate an explanation of some combination of relevant contract law principles, industry standards, common pitfalls, and jurisdiction-specific regulatory considerations for the contract type being reviewed. Then, in a process phase, a processor language model may review specific contracts along with the explanation in order to identify problematic clauses, suggest revisions, and/or flag potential compliance issues based on the provided legal framework.

Thus, the processor model can perform specialized legal analysis with enhanced accuracy by leveraging the contextual legal knowledge. Further, attorneys can deploy more efficient systems on more secure, local infrastructure rather than requiring extensive cloud resources and explanations can be tailored to different jurisdictions, industries, or contract types while maintaining consistent processing capabilities.

In a ninth example relating to code security vulnerability detection, during an explain phase, an explainer language model may generate explanations of security principles, language-specific vulnerability patterns, industry best practices, and emerging threat vectors relevant to the codebase being analyzed. Then, in a process phase, a processor language model may scan code repositories with the security explanation, identifying potential vulnerabilities, suggesting remediation approaches, and prioritizing issues based on severity and exploit likelihood.

Thus, the processor model can identify subtle security issues that would be missed without the contextual security knowledge. Organizations can implement scanning on developer machines or CI/CD pipelines without requiring extensive computational resources and without sending sensitive code and information to a remote LLM. Further, security explanations can be regularly updated with new vulnerability information without retraining the processor model.

In a tenth example relating to financial risk assessment, during an explain phase, an explainer language model may generate an explanation of some combination of current market conditions, economic indicators, industry-specific risk factors, and analytical frameworks appropriate for the financial assessment being performed. Then, during a process phase, a processor language model may analyze specific investment portfolios, financial statements, or market positions against the explanation to identify risk exposures, regulatory concerns, and to suggest mitigation strategies.

Thus, the processor model can provide more accurate and contextually appropriate financial analysis by incorporating current market conditions. Additionally, financial advisors can deploy systems with lower computational requirements and without sending sensitive information to a remote LLM. The approach allows for rapidly adapting to changing market conditions by updating explanations rather than retraining models.

Aspects of the disclosure may operate on particularly created hardware, firmware, digital signal processors, or on a specially programmed computer including a processor operating according to programmed instructions. The terms controller or processor as used herein are intended to include microprocessors, microcomputers, Application Specific Integrated Circuits (ASICs), and dedicated hardware controllers.

One or more aspects of the disclosure may be embodied in computer-usable data and computer-executable instructions, such as in one or more program modules, executed by one or more computers (including monitoring modules), or other devices. Generally, program modules include routines, programs, objects, components, data structures, etc. that perform particular tasks or implement particular abstract data types when executed by a processor in a computer or other device. The computer executable instructions may be stored on a computer readable storage medium such as a hard disk, optical disk, removable storage media, solid state memory, Random Access Memory (RAM), etc. As will be appreciated by one of skill in the art, the functionality of the program modules may be combined or distributed as desired in various aspects. In addition, the functionality may be embodied in whole or in part in firmware or hardware equivalents such as integrated circuits, FPGAs, and the like.

Particular data structures may be used to more effectively implement one or more aspects of the disclosure, and such data structures are contemplated within the scope of computer executable instructions and computer-usable data described herein.

The disclosed aspects may be implemented, in some cases, in hardware, firmware, software, or any combination thereof. The disclosed aspects may also be implemented as instructions carried by or stored on one or more or computer-readable storage media, which may be read and executed by one or more processors. Such instructions may be referred to as a computer program product. Computer-readable media, as discussed herein, means any media that can be accessed by a computing device. By way of example, and not limitation, computer-readable media may comprise computer storage media and communication media.

Computer storage media means any medium that can be used to store computer-readable information. By way of example, and not limitation, computer storage media may include RAM, ROM, Electrically Erasable Programmable Read-Only Memory (EEPROM), flash memory or other memory technology, Compact Disc Read Only Memory (CD-ROM), Digital Video Disc (DVD), or other optical disk storage, magnetic cassettes, magnetic tape, magnetic disk storage or other magnetic storage devices, and any other volatile or nonvolatile, removable or non-removable media implemented in any technology. Computer storage media excludes signals per se and transitory forms of signal transmission.

Communication media means any media that can be used for the communication of computer-readable information. By way of example, and not limitation, communication media may include coaxial cables, fiber-optic cables, air, or any other media suitable for the communication of electrical, optical, Radio Frequency (RF), infrared, acoustic or other types of signals.

The description of embodiments has been presented for purposes of illustration and description. Suitable modifications and variations to the embodiments may be performed in light of the above description. The described systems are exemplary in nature, and may include additional elements and/or omit elements. The subject matter of the present disclosure includes all novel and non-obvious combinations and sub-combinations of the various systems and configurations, and other features, functions, and/or properties disclosed.

The foregoing described aspects depict different components contained within, or connected with different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected,” or “operably coupled,” to each other to achieve the desired functionality.

As used in this application, an element or step recited in the singular and proceeded with the word “a” or “an” should be understood as not excluding plural of said elements or steps, unless such exclusion is stated. Furthermore, references to “one embodiment” or “one example” of the present disclosure are not intended to be interpreted as excluding the existence of additional embodiments that also incorporate the recited features. The terms “first,” “second,” “third,” and so on are used merely as labels, and are not intended to impose numerical requirements or a particular positional order on their objects. The following claims particularly point out subject matter from the above disclosure that is regarded as novel and non-obvious.

Also, when reference is made in this application to a method having two or more defined steps or operations, the defined steps or operations can be carried out in any order or simultaneously, unless the context excludes those possibilities.

Although specific examples of the invention have been illustrated and described for purposes of illustration, it will be understood that various modifications may be made without departing from the spirit and scope of the invention. Accordingly, the invention should not be limited except as by the appended claims.

1. A computer-implemented method for improving language model performance, comprising:
prompting an explainer language model to generate a natural-language explanation of a system or phenomenon relevant to completion of a task of interest;
storing the explanation in a storage device; and
prompting a processor language model to generate a response to the task of interest, wherein the explanation is provided within a context window of the processor language model to inform processing by the processor language model.

2. The computer-implemented method of claim 1, wherein the explanation is arranged to describe principles, structures and/or constraints of the system or phenomenon that are relevant to the task of interest.

3. The computer-implemented method of claim 1, wherein the storage device is a computer memory.

4. The computer-implemented method of claim 1, wherein the explainer language model and the processor language model are the same language model.

5. The computer-implemented method of claim 1, wherein the explainer language model is a large language model (LLM).

6. The computer-implemented method of claim 1, wherein the processor language model is a small language model (SLM).

7. The computer-implemented method of claim 1, wherein the processor language model is a multimodal model.

8. A system, comprising:
a computing device comprising one or more non-transitory computer-readable storage media storing instructions that, when executed by one or more processors, cause the one or more processors to:
via an explainer language model, generate an explanation of a linguistic paradigm corresponding to a task of interest based on an inputted instruction template;
provide the explanation as context to a processor language model; and
via the processor language model, generate a response to the task of interest based on the explanation as context.

9. The system of claim 8, wherein the computing device comprises a cloud computing device, wherein both the explainer language model and the processor language model are stored in the memory of the cloud computing device.

10. The system of claim 8, wherein the one or more processors are further configured to transfer the explanation to an edge device that stores the processor language model.

11. The system of claim 8, wherein the processor language model is a small language model (SLM) and the explainer language model is a large language model (LLM).

12. The system of claim 8, wherein the processor language model and the explainer language model are the same language model.

13. The system of claim 8, wherein the instruction template specifies the linguistic paradigm of the task of interest and a target audience.

14. A computer-implemented method for efficient deployment of language models on edge devices with limited computational resources, comprising:
generating, using an explainer language model, a natural-language explanation of a system or phenomenon that is relevant to completion of a task of interest;
transferring the explanation to an edge device, wherein the edge device comprises a processor;
storing the explanation in a memory of the edge device; and
prompting the processor language model on the edge device to generate a response to the task of interest, wherein the explanation is provided within a context window of the processor language model to inform processing by the processor language model.

15. The computer-implemented method of claim 14, wherein the explainer language model and the processor language model are the same language model.

16. The computer-implemented method of claim 14, wherein the explainer language model is a large language model (LLM).

17. The computer-implemented method of claim 14, wherein the processor language model is a small language model (SLM).

18. The computer-implemented method of claim 14, wherein the processor language model is a multimodal model.

19. The computer-implemented method of claim 14, wherein the explainer language model is executing on a server.

20. The computer-implemented method of claim 14, wherein the processor is executing a processor language model with fewer parameters than the explainer language model.
